(19) United States
(12) Patent Application Publication
(10) Pub. No.: US 2012/0009010 A1
(43) Pub. Date: Jan. 12, 2012

(54) CABINET CONNECTOR STRUCTURE

(76) Inventor: Chan-Lin WU, DALY CITY, CA (US)

(21) Appl. No.: 12/834,262

(22) Filed: Jul. 12, 2010

(51) Int. Cl. F16D 1/00

(52) U.S. Cl. 403/217

(57) ABSTRACT

A cabinet connector structure includes a base, radial latch slots formed on a connecting side of the base and equidistantly arranged from each other, and adjacent latch slots being arranged at an angle of substantially 60 degrees, an insert section disposed on an external side of the base, and six embedding slots formed on a circumferential surface of the insert section and being arranged at an equal angle with each other, and the embedding slots being disposed alternately and perpendicular to each other, such that the connector structure can be used for connecting a rod type frame or panel non-perpendicularly through the six latch slots to complete assembling a cabinet, and the structure breaks through conventional products of this sort that can be used for a perpendicular assembly.

### BACKGROUND OF THE INVENTION

1. Field of the Invention

The present invention relates to a cabinet connector structure, and more particularly to a structure whose connector includes latch slots, and adjacent latch slots are arranged with a predetermined angle non-perpendicular to each other, such that the connector structure used for connecting a rod type frame or panel can break through the limitation of the conventional perpendicular assembling relation and provide a more flexible assembling configuration and enhance the scope of applicability and the value of a cabinet connector.

2. Description of the Related Art

In general, a structural design of a rack or a cabinet made of rod type frames or panels adopts plastic connectors as its connecting components, and latch slots are formed on the connectors and provided for inserting rods of the rod type frame or panel to achieve the effects of assembling the rack or cabinet quickly and providing a repeated use of the connectors.

With reference to FIG. 1 for a conventional connector structure, the structure comprises: a disc-shaped base 10; four latch slots 11 arranged into a cross shape and formed on a connecting side of the base 10, such that adjacent latch slots 11 are disposed perpendicular to each other; non-planar ribs 12 formed on an internal wall of each latch slot 11; an insert section 13 disposed on an external side of the base 10, four embedding slots 14 having an equal included angle and arranged equidistantly from each other and disposed laterally on a circumferential surface of the insert section 13, wherein the embedding slots 14 have a size equal to the interval between two adjacent latch slots 11, and the embedding slots 14 are perpendicular to the latch slots 11; and non-planar ribs 15 formed on an internal wall of the embedding slot 14. The latch slots 11 formed on the connecting side of the base 10 is provided for inserting and connecting the rod type frames or rod type panels to constitute a framework of the rack or cabinet, and an embedding slot 14 is formed at the insert section 13, if needed, for inserting and connecting the rack panels to define a containing space of the rack or cabinet, and using the containing space for displaying objects.

However, the latch slots of the connector are arranged with an angle of 90 degrees, and thus rods of the rod type frames or panels can be connected perpendicular to each other. As a result, the assembling spatial configuration is limited significantly, and users cannot assemble the rack or cabinet flexibly as needed. Obviously, the conventional connector structure requires improvements.

### SUMMARY OF THE INVENTION

In view of the aforementioned shortcomings of the conventional connector structure having 90-degree latch slots, the inventor of the present invention based on years of experience in the related industry to conduct extensive researches and experiments, and finally developed a cabinet connector structure in accordance with the present invention.

Therefore, it is a primary objective of the invention to provide a cabinet connector structure with latch slots that allows the assembly of the rod type frame or panel to be connected more flexible according to user requirements, so as to break through the limitation of the conventional right-angle connection mode.

Another objective of the present invention is to provide a design of a connector structure that allows users to select appropriate latch slots according to the size of disposed objects to assemble a cabinet, so as to provide the necessary containing space and prevent a waste of space.

A further objective of the present invention is to provide a design of a structural assembly, such that a rack or a cabinet can be connected at different angles to enhance the variety and flexibility of the application configuration.

To achieve the aforementioned objective, the present invention provides a cabinet connector structure comprising six latch slots, and adjacent latch slots are arranged at predetermined angles and disposed non-perpendicular to each other, such that when the rod type frames or panels are embedded and connected, the invention breaks through the limitation of the conventional perpendicular connection, and provides a more flexible assembling configuration to enhance the scope of applicability and value of the connector structure.

### BRIEF DESCRIPTION OF THE DRAWINGS

FIG. 1 is a schematic view of a conventional cabinet connector structure;

FIG. 2 is a schematic view of a cabinet connector structure of the present invention;

FIG. 3 is another schematic view of a cabinet connector structure of the present invention;

FIG. 4 is an exploded view of a cabinet connector structure in accordance with a preferred embodiment of the present invention;

FIG. 5 is a perspective view of a cabinet connector structure in accordance with a preferred embodiment of the present invention;

FIG. 6 is a schematic view of using a cabinet connector structure in accordance with a preferred embodiment of the present invention;

FIG. 7 is a schematic view of using a cabinet connector structure in accordance with another preferred embodiment of the present invention; and

FIG. 8 is a schematic view of using a cabinet connector structure in accordance with a further preferred embodiment of the present invention.

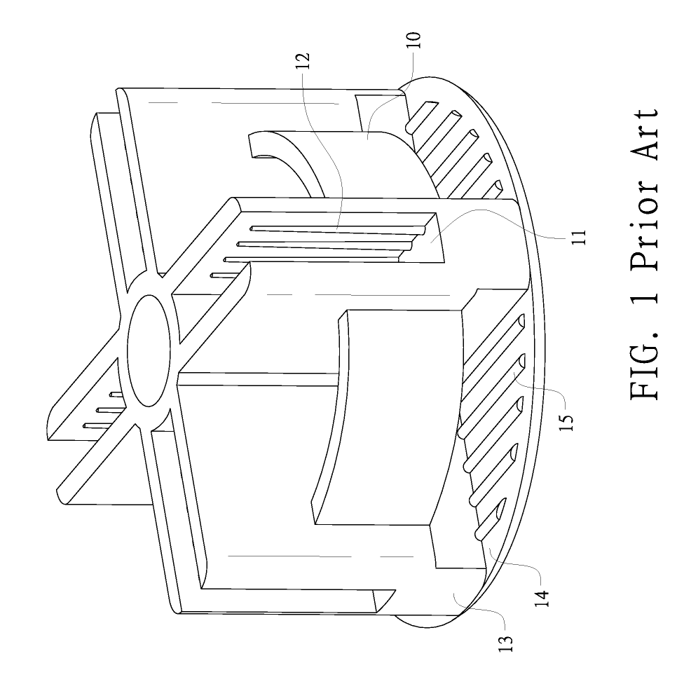

### DETAILED DESCRIPTION OF THE PREFERRED EMBODIMENTS

The technical characteristics of the present invention will become apparent with the detailed description of preferred embodiments and the illustration of related drawings as follows.

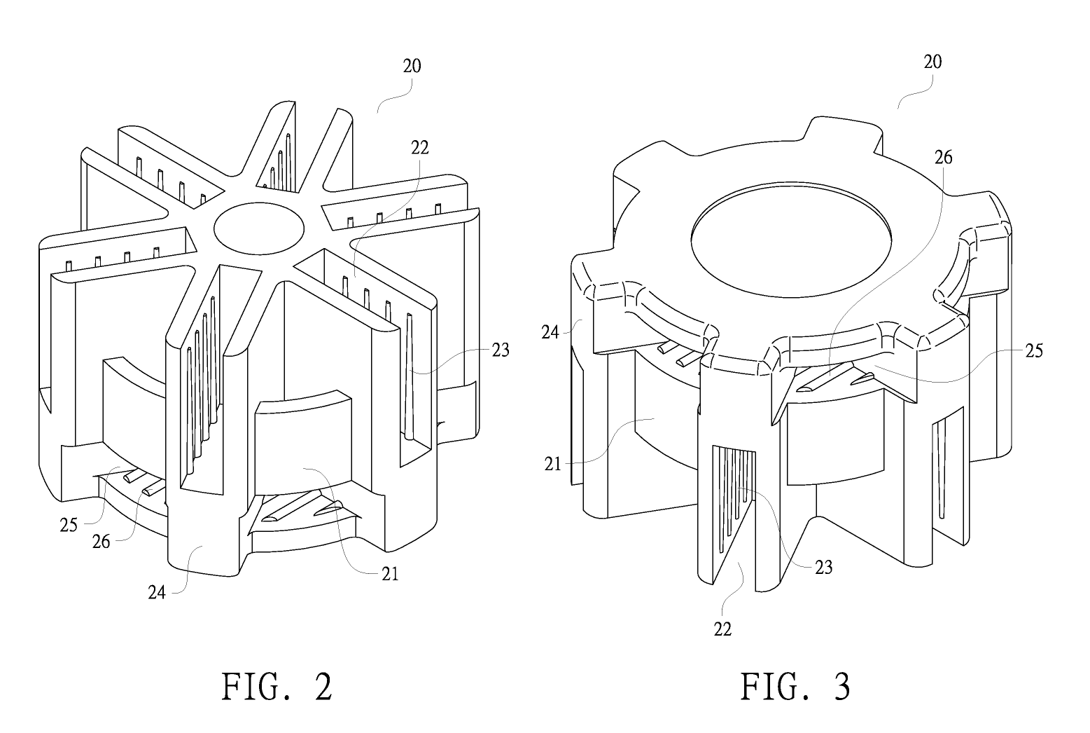

With reference to FIGS. 2 and 3 for schematic views of a connector structure in accordance with a preferred embodiment of the present invention, a structural design of a connector 20 of the present invention comprises: a base 21; six latch slots 22 arranged into a radial form and equidistantly disposed on a connecting side of the base 21, wherein adjacent latch slots 22 are arranged at an angle of 60 degrees; a plurality of non-planar ribs 23 formed on an internal wall of the latch slot 22, an insert section 24 disposed on an external side of the base 21; six embedding slot 25 having an equal angle, and formed laterally on a circumferential surface of the insert section 24, and disposed between two adjacent latch slots 22 and perpendicular to each other; and a plurality of non-planar ribs 26 formed on an internal wall of the embedding slot 25.

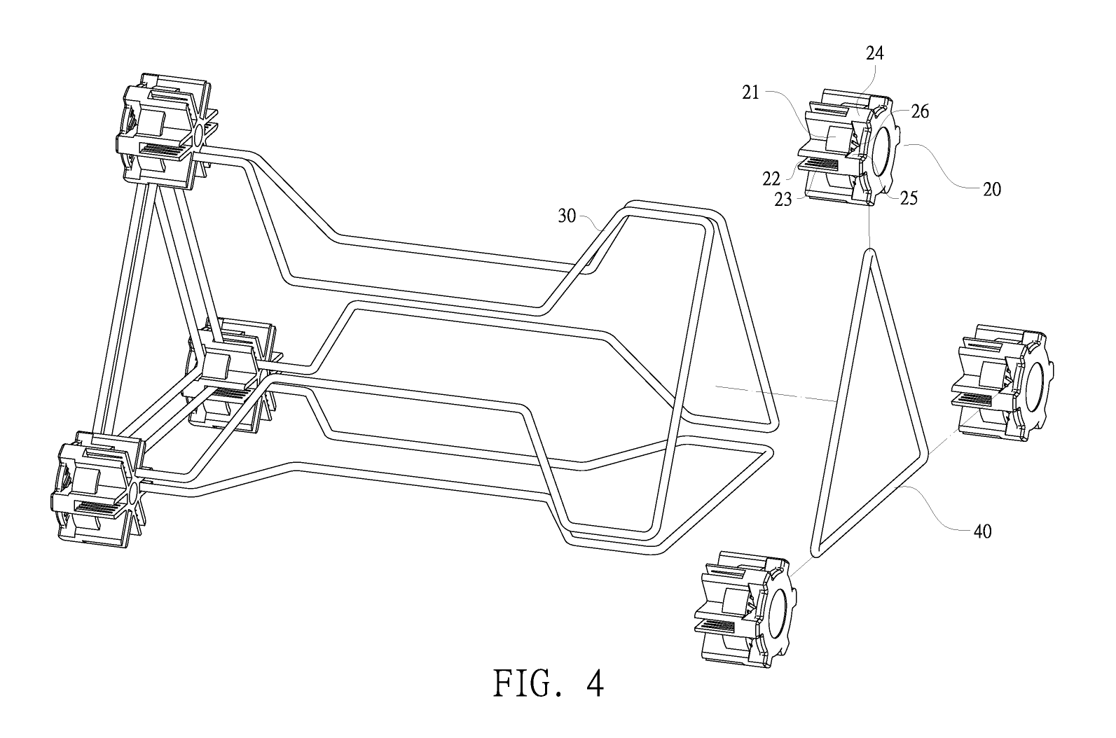

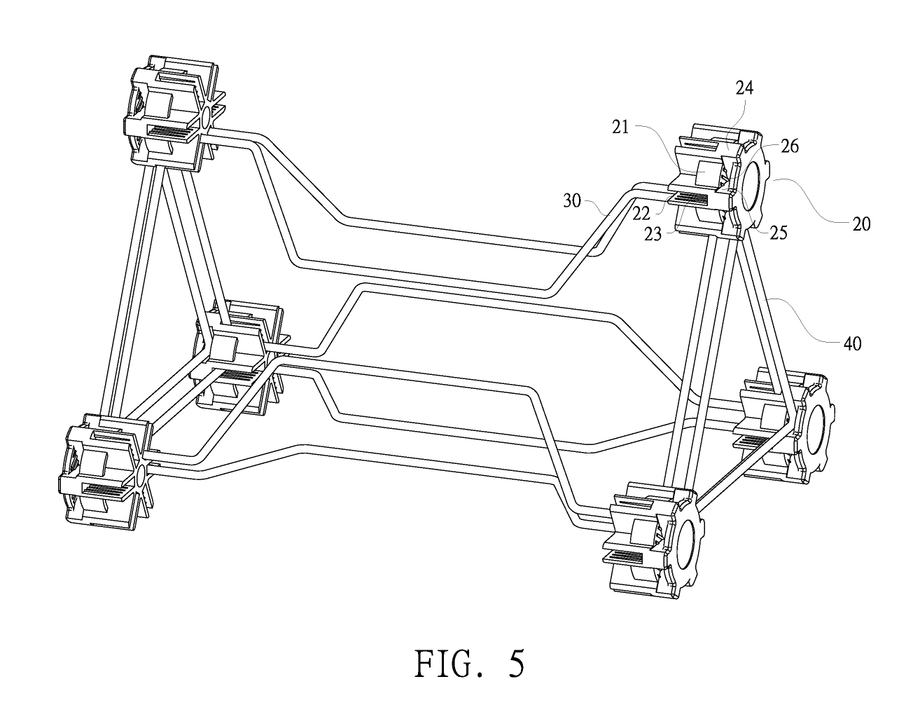

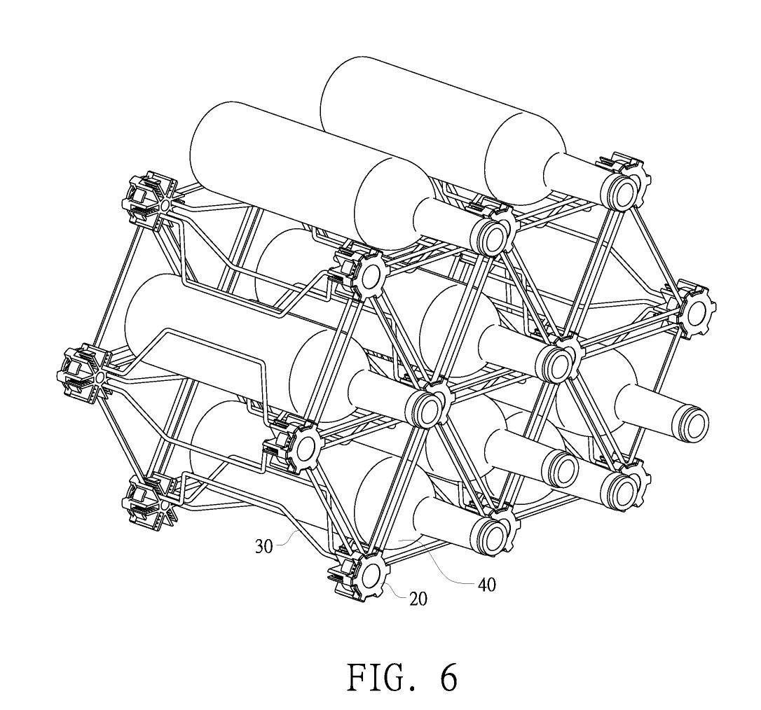

With reference to FIGS. 4 to 6 for an exploded view, a perspective view and a schematic view of a cabinet connector structure in accordance with a preferred embodiment of the present invention respectively, the structure is applied to a wine rack, wherein latch slots 22 and embedding slots 25 are formed on a connector 20, and adjacent latch slots 22 are arranged at an angle of 60 degrees (wherein the adjacent latch slots 22 are non-perpendicular to each other), such that appropriate latch slots 22 of another rod type frame 30 can be selectively embedded and connected to form a triangular rack. If needed, embedding slots 25 are formed at both ends of the rack and provided for inserting and connecting the insert section 24 of the connector 20 to produce a triangular rod type frame 40, so as to reinforce and maintain the assembling configuration. In the meantime, the non-planar ribs 23, 26 formed on internal walls of the latch slots 22 and embedding slots 25 can improve the stability of the insertion, embedment and connection of a plurality of rods 30, 40 and define a plurality of triangular spaces in the wine rack, so as to achieve the effects of placing and positioning wine bottles, and minimizing the storage space to avoid a waste of spaces.

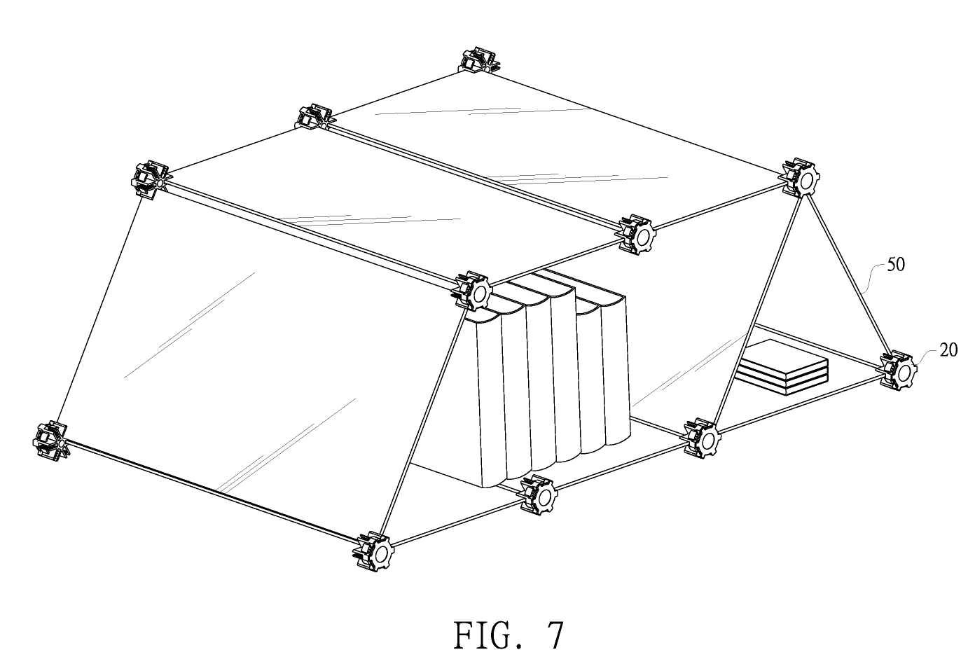

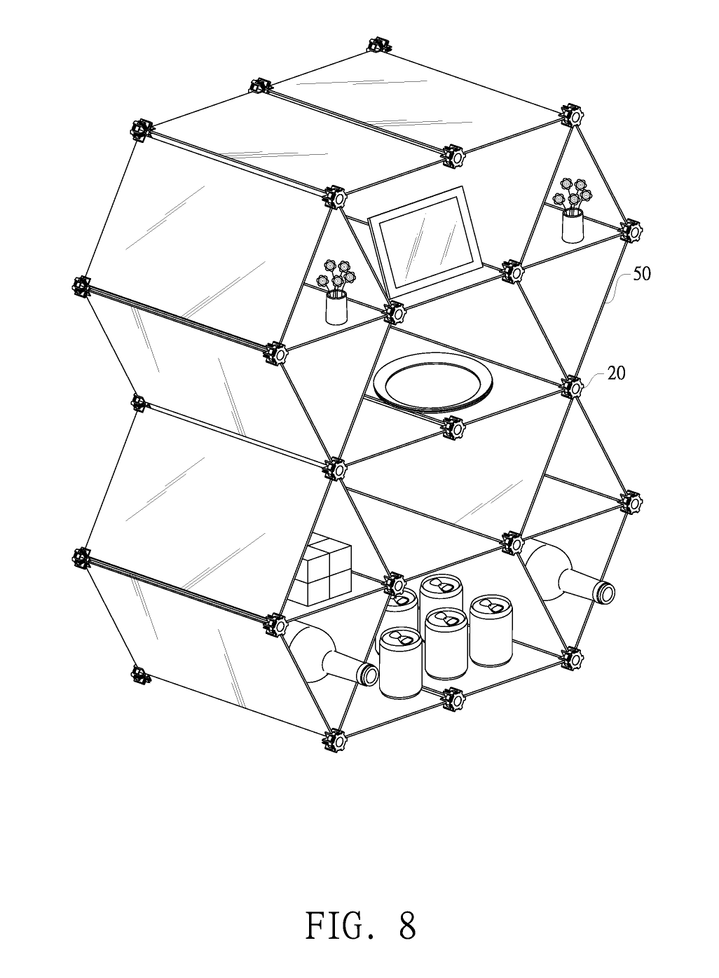

With reference to FIGS. 7 and 8 for schematic views of using a cabinet connector structure in accordance with preferred embodiments of the invention respectively, the invention can be used for other applications. In addition to the wine rack, the structural design of the connector 20 in accordance with the present invention can be used for assembling a bookshelf or a storage cabinet according to the actual using requirement, wherein the latch slots 22 of the connector 20 are provided for embedding and connecting the rod type panel 50. The multi-directional design of the latch slots 22 allows the frame or cabinet to have an appropriate containing space, and the embedding slots 25 on the insert section of the connector 20 can be formed on one of the lateral positions, such that the frame panel (not shown in the figure) can be inserted and connected to form a semi-enclosed containing space, and the frame or rack is provided for the use as a bookshelf or a general cabinet.

With the aforementioned structural design having six latch slots and six embedding slots, the invention can break through the limitation of the conventional way of inserting or embedding the connectors to assemble the rack or cabinet and allow users to select a multi-directional connection of the rod type frame or panel with a non-perpendicular relation, so as to break through the conventional perpendicular assembling limitation and provide a more flexible assembling application. In the meantime, the invention enhances the variety and flexibility of the installation configurations.

In summation of the description above, the structural design of the cabinet connector of the present invention arranges the latch slots at non-perpendicular predetermined angles, such that the rod type frame or panel can be connected at multi-directional angles flexibly to cope with the practical application requirement and break through the limitation of the right-angled configuration of the products of this sort. Obviously, the invention can improve over the prior art and comply with the patent application requirements, and thus is duly filed for patent application.

While the invention has been described by device of specific embodiments, numerous modifications and variations could be made thereto by those generally skilled in the art without departing from the scope and spirit of the invention set forth in the claims.

What is claimed is:

1. A cabinet connector structure, designed for coupling a rod type frame or panel, and whose connector comprising a base, and a plurality of latch slots formed on a connecting side of the base and provided for selectively and appropriately inserting and embedding the rod type frame or panel, characterized in that the latch slots formed on the connecting side of the connector are six latch slots radially formed and equidistantly arranged from each other, and adjacent latch slots having an angle of substantially 60 degrees.

2. The cabinet connector structure of claim 1, further comprising a non-planar rib formed on an internal wall of the latch slot.

3. A cabinet connector structure, designed for coupling a rod type frame or panel, and whose connector comprising a base, a plurality of latch slots formed on a connecting side of the base, a plurality of insert sections disposed on an external side of the base, a plurality of embedding slots formed laterally on a circumferential surface of the insert section, and disposed at positions perpendicular to the latch slots, such that the latch slots and the embedding slots are provided for selectively and appropriately inserting and embedding the rod type frame or panel to assemble a cabinet, characterized in that the latch slots formed on the connecting side of the connector are six latch slots radially formed and equidistantly arranged from each other, and adjacent latch slots are arranged at an angle of substantially 60 degrees, and the embedding slots formed laterally on the circumferential surface of the insert section are six embedding slots having equal angles with each other, and the embedding slots are disposed alternately and perpendicular to each other.

4. The cabinet connector structure of claim 3, further comprising a plurality of non-planar ribs formed on internal walls of the latch slot and the embedding slot respectively.
